(19) United States
(12) Patent Application Publication
(10) Pub. No.: US 2003/0103230 A1
(43) Pub. Date: Jun. 5, 2003

(54) Graphic system utilizes backgrounds of 1,000,000 symbols

(76) Inventor: Edward Patrick Aka E Patrick Flannery, Littleton, CO (US)

Correspondence Address: E. Patrick Flannery, 5900 South Jellison #A, Littleton, CO, 80123, US

(21) Appl. No.: 10/000,994

(22) Filed: Nov. 30, 2001

(51) Int. Cl. B41F 1/00; G06F 15/00

(52) U.S. Cl. 358/1.14; 358/1.18

(57) ABSTRACT

Within graphics state-of-the-art, the FLANNERY invention is a system that builds a basic symbol about one millimeter square into a million symbol master background organized into identifiable inherent groups of 100, 1,000, 10,000 “square”, and 100,000; printed in a light color (see FIG. 2). The system utilizes modified symbols in a designated position to key blocks to fill some 12 square feet on a nominally 4×4 foot sheet. Prototype utilizes a half sheet with 500,000 on each side. Design permitting “double up” narrowed symbols would fill some 6 square feet on the same size half sheet; 1,000,000 on one side. Subsequent surprinting in darker colors maintain all symbol characteristics in desired design creates the graphic. All symbols discernible by persons with 20/20 vision at normal reading distance. Akin to a mosaic with inlay of small stones, as viewing distance increases, these fuse together optically to form an image. The FLANNERY invention not only has impact to show a million items graphically, but also has international marketing potentials as a promotional piece, novelty, or souvenir. The mystique of a “millionaire” is especially evoked when used with monetary symbols, which has viable longer range potentials for fund raising.

### CROSS-REFERENCE TO RELATED APPLICATIONS

Not Applicable.

### BACKGROUND—FIELD OF THE INVENTION

This invention relates to charts and posters, for any entity relating to a million, from a souvenir novelty, to fund raising campaigns, within printing state of the art.

### BACKGROUND—DESCRIPTION OF PRIOR ART

The mystique of a “million” and “millionaire” has become long entrenched in the entire world. These terms imply inestimable quantities or fabulous wealth. English phrases include “a million bucks,” “bet a million,” “worth millions.” Song lyrics draw on this phenomenon with “A million or more times,” “I'd walk a million miles,” “Million dollar baby in a 5¢ & 10¢ store.” The American Revolutionary War popular song “Yankee Doodle” satires General Washington's troops: “There must have been a million.” At a cost of $1,000,000 in 1882, a road was carved through mountains in southwestern Colorado. This seven mile long stretch is now known as “The Million Dollar Highway.”

In 1970 Simon and Schuster published One Million, copyrighted by Hendrik Hertzberg. The booklet has 200 pages, 8½″×11″, each having 5,000 dots, 111 per square inch. Notes intermittently placed compare quantities from Garden of Eden's population (2) . . . Iran's square miles (636,128) . . . dots in this book (1,000,000). (See FIG. 1-A.)

Novelties resembling paper currency have been years on the market. From posters to notebook covers, advertising specialties to souvenirs. Some $1,000,000 replicas were printed poster size. More sophisticated replicas in two or more colors, but as of patent filing date, we have yet to find one printed on the reverse side as well. (See FIG. 1-B.)

### OBJECTS AND ADVANTAGES

FLANNERY's invention provides a master background for poster graphics, beyond prior state of the art, comprised of 1,000,000 tiny symbols printed in light ink. Said symbols in the prototype are some one millimeter square, still large enough for persons with 20/20 vision to discern said symbols and modifications. An inherent system enables viewers to identify blocks keyed for 100, 1,000, 10,000 “square,” and 100,000 using graphic techniques singularly or in combination. Prototype's background measures some 46″×19″ (some 12 square feet) with 500,000 symbols on both sides of a 50″×20″ sheet. Using the master back film negative as a contact screen, symbol characteristics are integrated with the graphic desired, one offset plate for each darker color surprinted.

Akin to mosaics, very small images fuse optically as viewing distance increases. The realization that the massive total of a million units are being viewed makes this more than just a usual novelty. Monopoly, Milton Bradley's popular parlor game of the 1930's, often induced euphoria of being a “millionaire”. Especially with the use of monetary symbols, the FLANNERY system can also evoke such positive responses—with added fund raising potentials. Further utilization will be self-evident as you proceed. Smaller reproductions than the 50″×20″ prototype can be designed needing magnification. Mega-graphics also likely for outdoor billboards and architectural decor. (See FIG. 3-D.)

### ILLUSTRATION FIGURES

FIG. 1-A Page from ONE MILLION published by Simon & Schuster, 1970

1-B Notebook cover and wallet size bill

1-C Typical financial, national, secular, etc. symbols

1-D Modified dropout examples: round . . . square . . . triangular . . .

1-E Background use to gain width/height; Rotation on any axis

1-F Sans-serifs vs. serifs/Upright (Roman) vs. italic

FIG. 2 Definition diagram/Marginal marks (this drawing embodies the basic 1, 000,000 patent features )

FIG. 3-A Technique for establishing proportions

3-B Basic background-Misc. corner options/Spot surprints

3-C Checkerboarding/Pictorial surprint example

3-D Hairline outline (10,000 example)

3-E Architectural decor examples

### SUMMARY

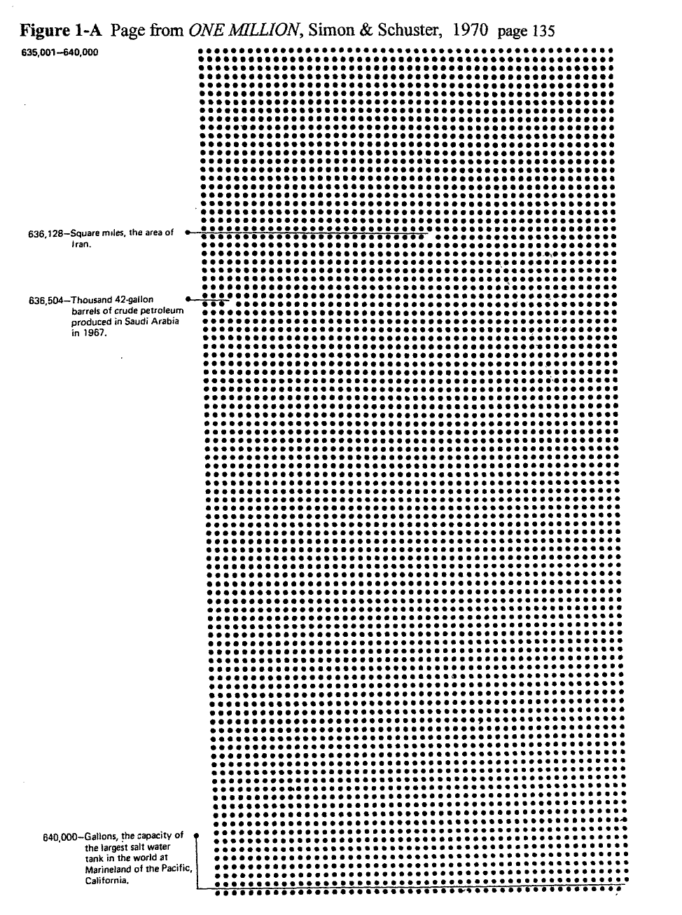

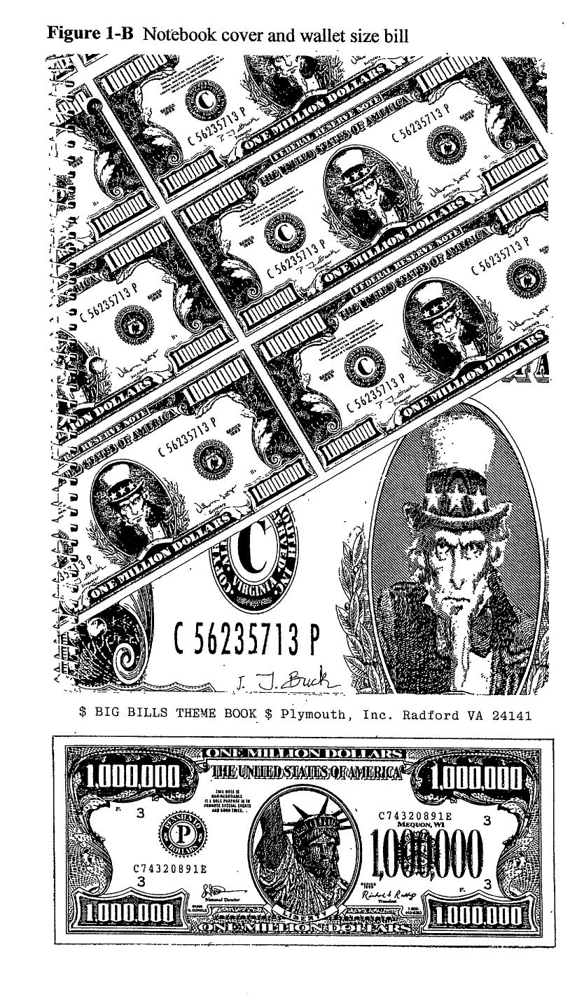

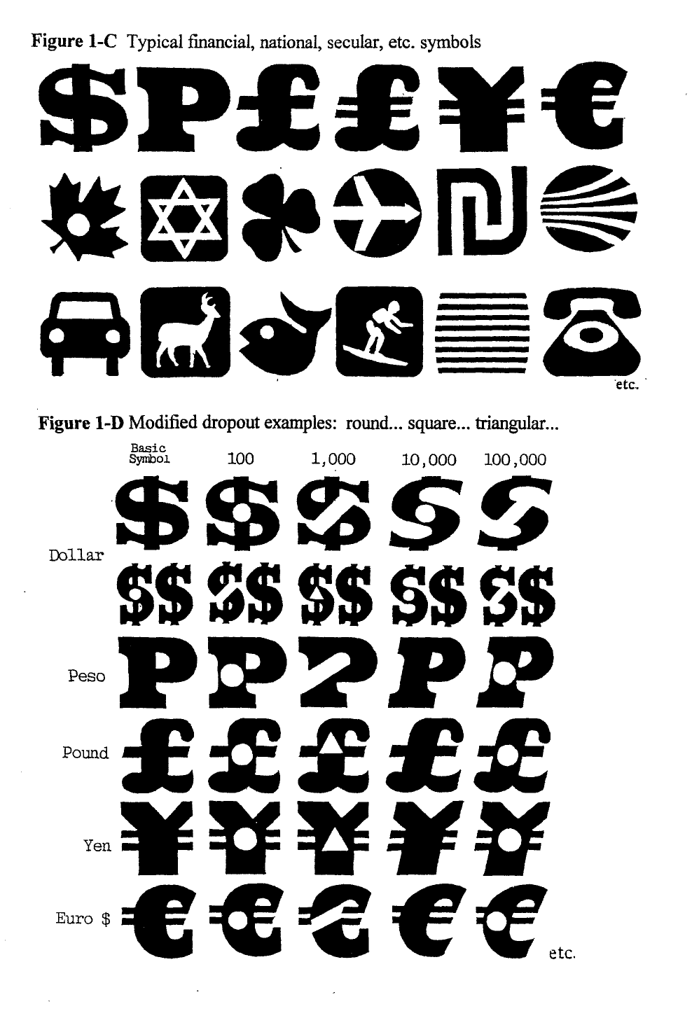

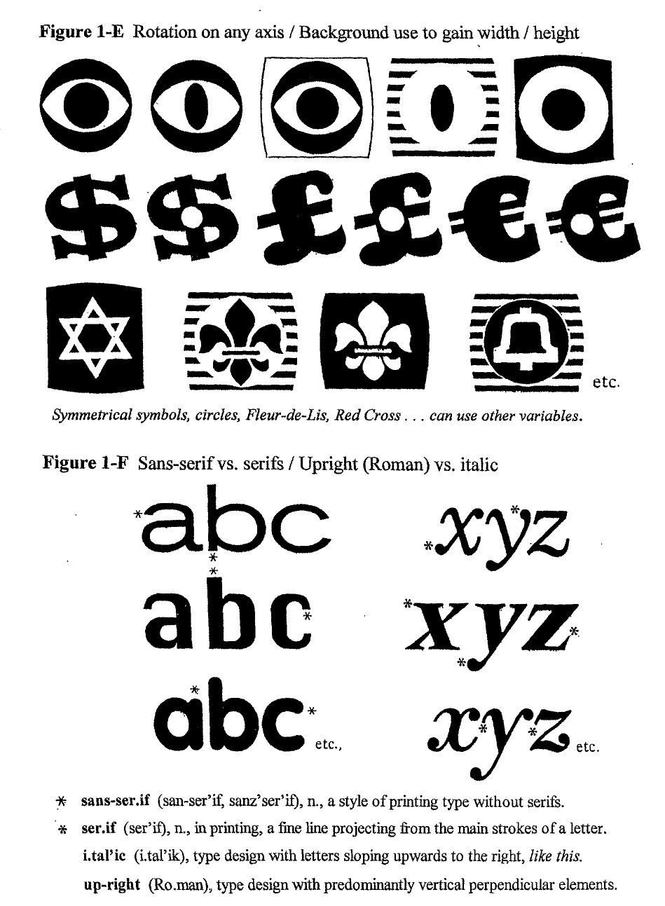

A system within state-of-the-art poster graphics, a master background in a light color of a million basic symbols within a definable space, so as to key and identify blocks of 100, 1,000, 10,000 “square,” and 100,000 (or other) blocks in a consistent designated position. The basic symbol a simple design, utilizing image some half of the area within a nominally square millimeter—1,000,000 symbols filling some 12 square feet, on a nominally 4×4 foot sheet. Prototype has 500,000 symbols each side of a half sheet. (Using a “double up” symbol 1,000,000 can fill the same size half sheet; see FIG. 1-D). Surprints in designs of desired graphic utilize master background's line negative as a contact screen to maintain characteristics of all symbols.

### DESCRIPTION OF PROCESS

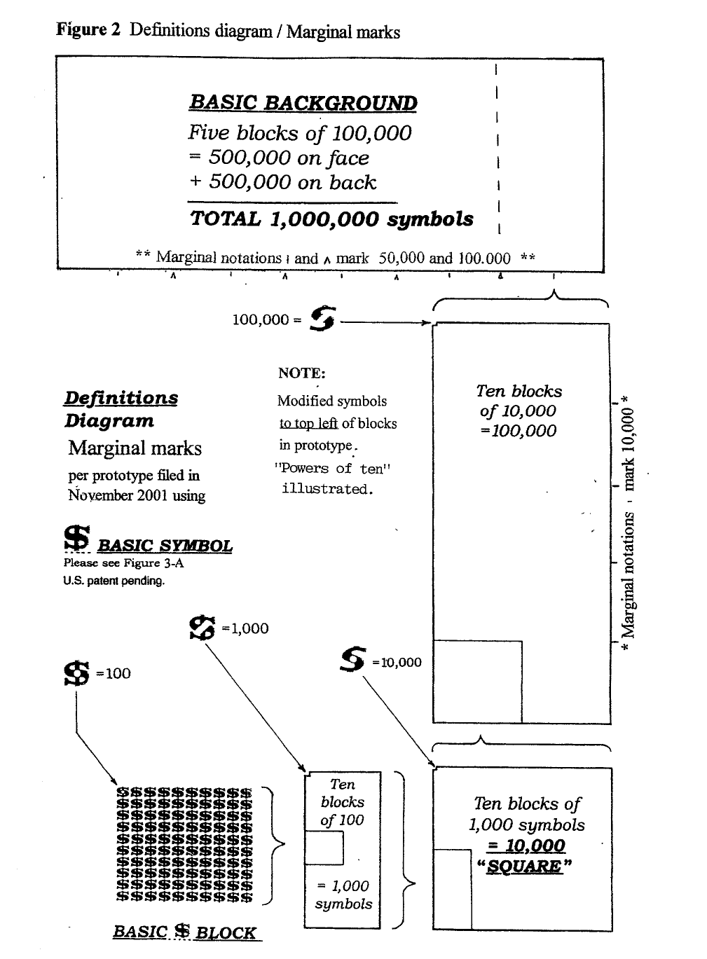

FLANNERY's basic invention builds a master background of a million symbols within state-of-the-art poster lithography. After first establishing proportions of background size to component blocks of 100,000, 10,000 “square,” 1,000, and 100—the basic unit height vs. width is finalized (see FIG. 2 for prototype).

Thence a basic block of ten symbols high, ten symbols wide—equaling a block of 100—is step and repeated to blocks of 1,000, 10,000, and 100,000. Concurrent with this phase, key symbols are modified (prototype uses top left comer), and positioned in place for above blocks. (See FIGS. 1-D -E & -F.)

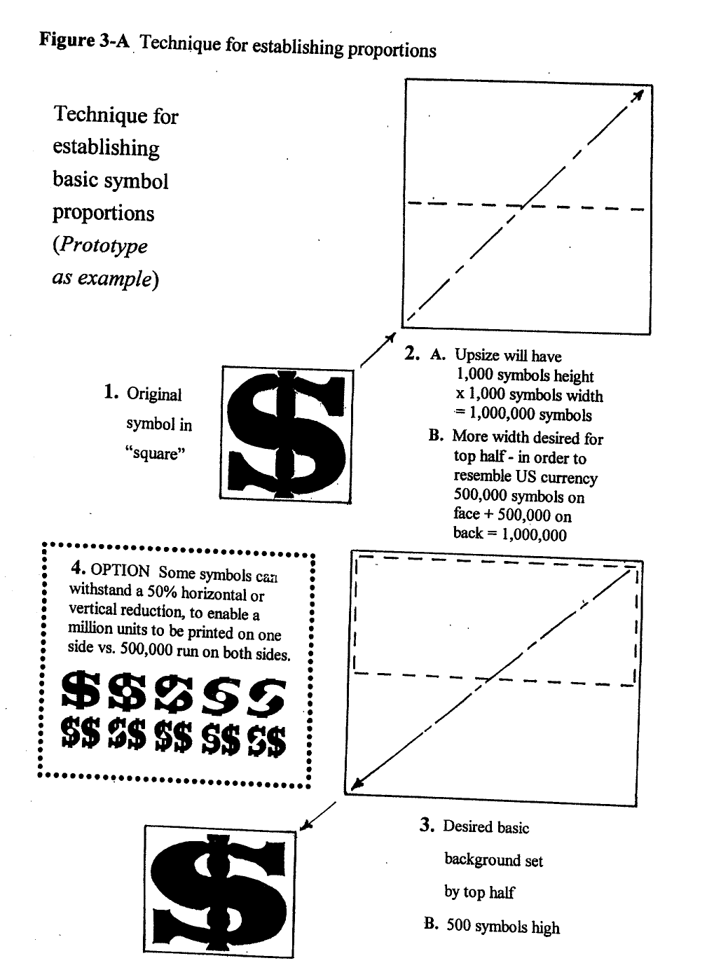

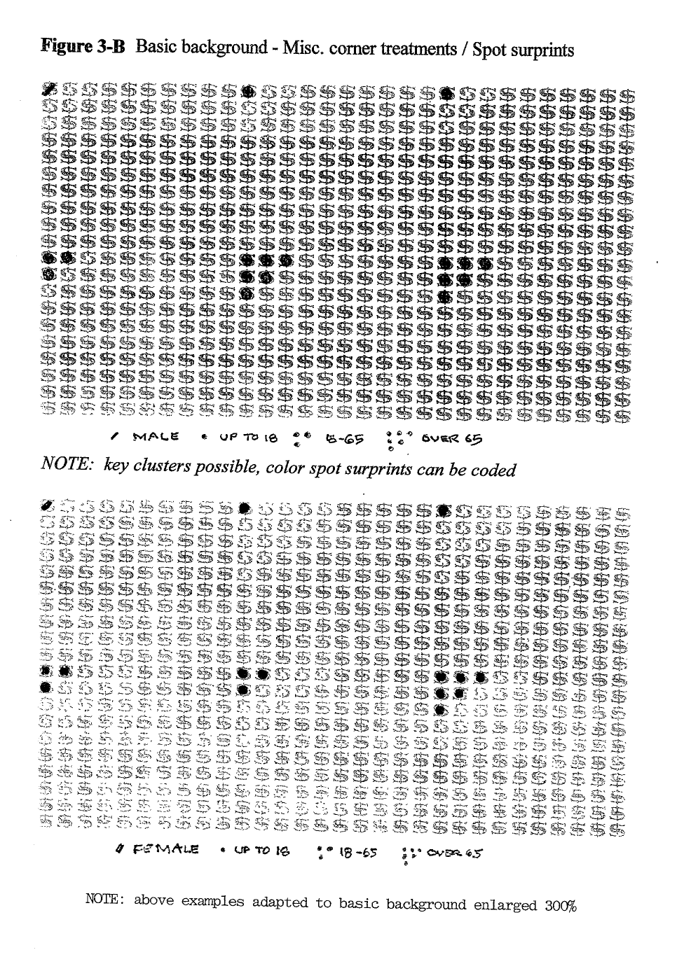

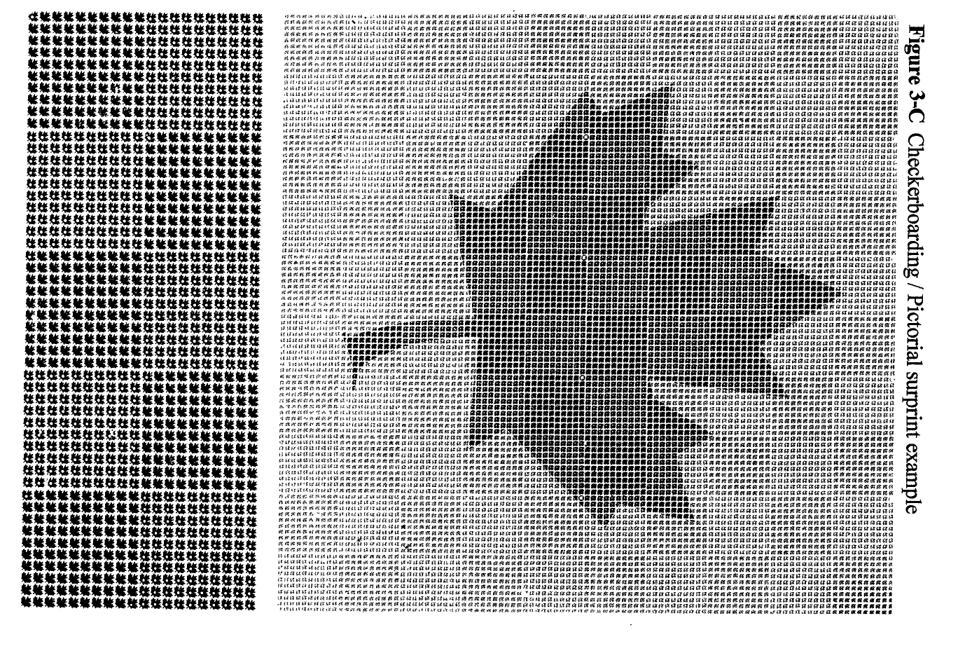

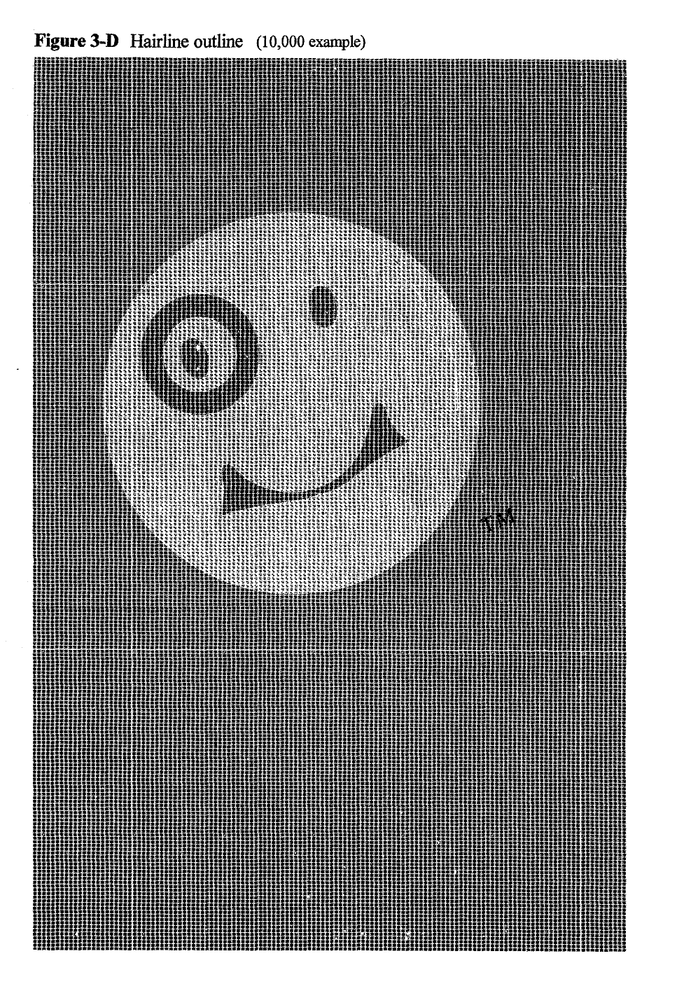

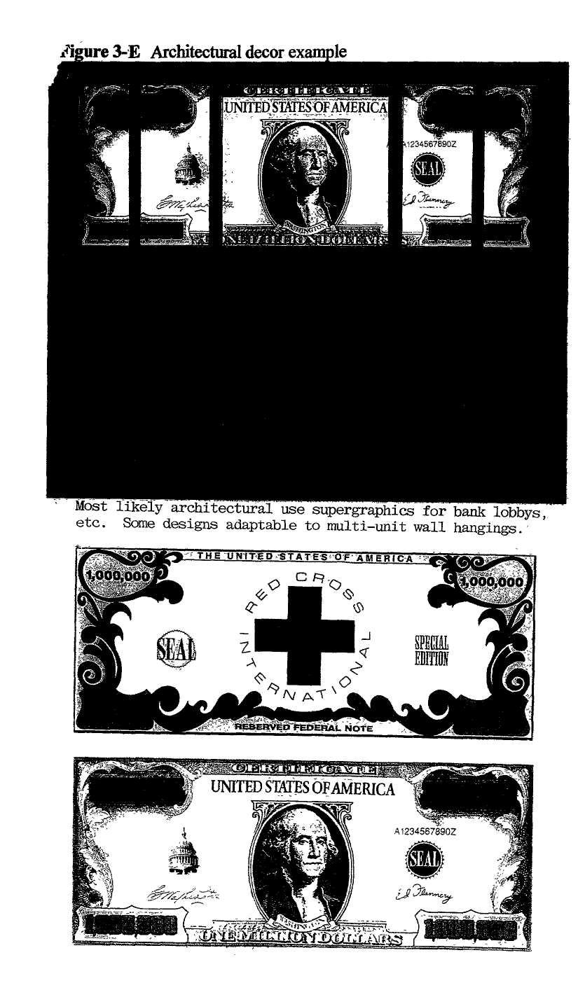

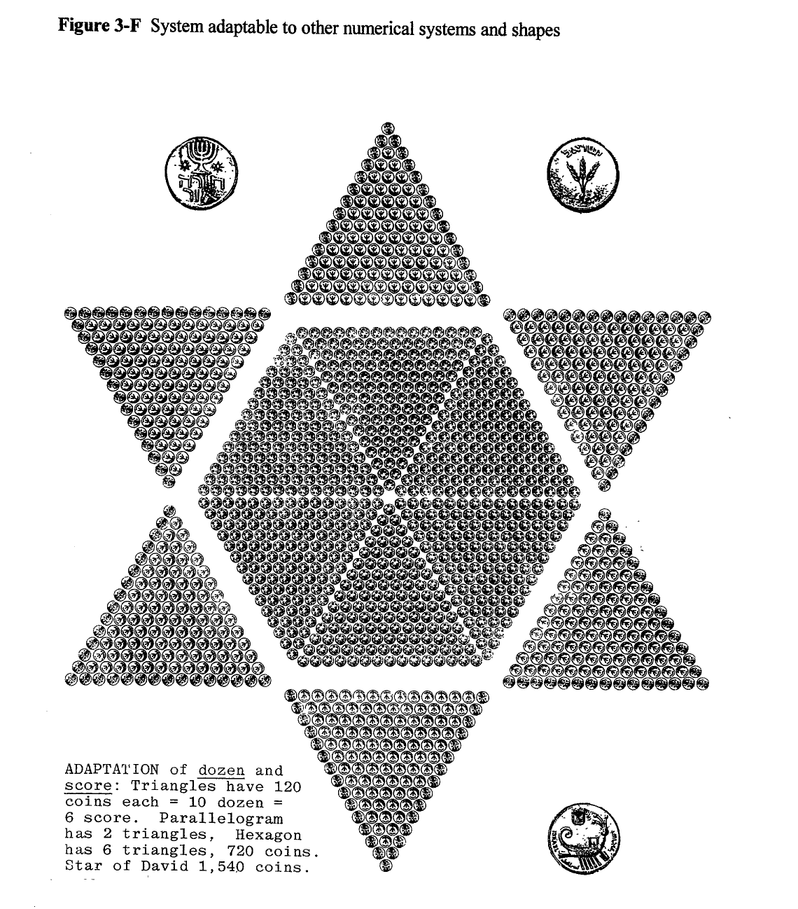

The master background is to be printed in a light color, the same line negative is used as a contact screen to maintain the characteristics of the symbol in subsequent surprinted darker colors. Mini or mega-graphics would also be feasible sizes ranging from a billfold size requiring magnification, to supergraphics for outdoor billboards or architectural decor (see FIG. 3-E).

I claim

1. a. Within lithographic state of the art a basic symbol 1/1,000 of a nominally square master background's height and 1/1,000 of the width is step and repeated to achieve blocks of 100, 1,000, 10,000, and 100,000 or other; said master background to be printed in light color ink; could also be run on both sides of a half size sheet 500,000each side; or symbol design permitting narrowed “double up” symbols to fit 1,000,000 to fill a like half size sheet.
b. At least four basic symbols modified to key and correspond with the blocks of 100, 1,000, 10,000, and 100,000 or other, prepositioned to the top left corner as in prototype, or other designated placement.
c. Visual effect resembles that of halftone dots, yet the characteristics of all said symbols are discernible to persons with 20/20 vision at normal reading distance; subsequent surprinting with darker colors, maintaining the symbol characteristics to create the graphic desired.

2. In similar fashion, a basic symbol is modified and replicated to a block of 100, placed next to a block of 100 basic non-modified symbols, thence to fill checker boarded master background, to be printed in light color, with keyed blocks and darker surprinting as in claim 1-a above,

3. a. To assist recognition of said blocks, vertical marks (|) alternating with a karat (ˆ ) horizontally immediately below the master background's lower margin, mark vertical columns of 50,000 and 100,000 blocks; likewise immediately outside the background's right margin, tiny dashes (—) mark horizontal rows of 10,000 blocks.
b. To further facilitate recognition of component blocks, for example, blocks of 10,000 could be framed with a hairline thin space.
